(19) United States
(12) Patent Application Publication
(10) Pub. No.: US 2002/0186012 A1
(43) Pub. Date: Dec. 12, 2002

(54) Magnetic resonance apparatus

(75) Inventor: To-Oru Yasuda, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 10/093,799

(22) Filed: Mar. 11, 2002

(30) Foreign Application Priority Data
Jun. 6, 2001 (JP) 2001-170801(P)

(51) Int. Cl. G01V 3/00

(52) U.S. Cl. 324/318; 324/309

(57) ABSTRACT

Disclosed is a magnetic resonance apparatus capable of measuring a distribution of impurities in a sample at high resolution without destroying the sample. A magnetic resonance apparatus has a cryostat for cooling and holding a sample, coils for applying an inclined magnetic field to a sample so that the intensity of the magnetic field has a gradient to the reference axis of the sample, a driving mechanism for moving the sample to which the magnetic field is applied with respect to the magnetic field, antennas for irradiating the sample to which the magnetic field is applied with an electromagnetic wave; and antennas for detecting an electromagnetic wave emitted from the sample irradiated with the electromagnetic wave.

### BACKGROUND OF THE INVENTION

1. Field of the Invention

The present invention relates to a magnetic resonance apparatus and, more particularly, a magnetic resonance apparatus for measuring a concentration distribution of impurities distributed in a semiconductor.

2. Description of the Background Art

In the case of forming a transistor on a silicon substrate as a semiconductor, an impurity such as phosphorus, arsenic, boron, or the like is ionized and implanted into a predetermined area in a substrate at high speed and, after that, annealing is carried out to recover a damage caused at the time of the implantation. A three-dimensional concentration distribution of the impurity exerts a large influence on the performances of a transistor. It is therefore very important to know the distribution of an impurity in an actual device in order to fabricate a semiconductor device of high quality.

The following methods are known as methods of obtaining an impurity concentration distribution.

(1) Simulation

Usually, an impurity concentration distribution in a semiconductor device is measured by performing a simulation on the basis of parameters of a fabricating process and an actually measured physical quantity. The parameters in the fabricating process of a semiconductor device and a procedure of obtaining an impurity concentration distribution from the parameters by running a simulation will be described hereinbelow.

Methods of introducing an impurity into a semiconductor device are roughly divided into implantation and diffusion.

In the case of implanting an impurity, discharge takes place in a source gas containing impurity atoms. Only target ions are separated from generated ions by a mass spectrograph. The target ions are accelerated by an electric field and implanted in a semiconductor substrate. At this time, the speed of the ions to be implanted is known from the intensity of the electric field. By monitoring a current value of an ion beam, the number of ions implanted can be known. Further, from an angle formed between the ion beam and the semiconductor substrate, the direction of entry of the impurity into the semiconductor substrate can be known.

By preliminarily forming a photoresist or the like as a mask in an area to which an impurity is not desired to be implanted on the surface of the semiconductor substrate so that the entry of ions can be checked, the ions can be implanted only to a desired area.

In order to obtain the concentration distribution of an impurity in a semiconductor device in accordance with the implantation parameters as described above, it is sufficient to know the ion speed dependency of implantation depth of ions in a silicon of the semiconductor substrate (what is called nucleus stopping power). The value varies according to nuclear species and has to be obtained by experiments. For this purpose, the depths from the surface of ions implanted at various speeds have to be analyzed by secondary ion mass spectrometry or the like.

In the case of doping an impurity by a diffusion method, a semiconductor substrate is heated in an atmosphere containing the impurity. According to the method, an impurity is introduced from the surface of the semiconductor substrate where the concentration is high to the inside by using a phenomenon that a substance moves from an area of high concentration to an area of low concentration. The degree of thermal diffusion can be controlled by the temperature of the semiconductor substrate and time of maintaining the temperature. In order to obtain the concentration distribution of an impurity in a device from such diffusion parameters, a diffusion coefficient of the impurity in silicon has to be obtained. The diffusion coefficient is experimentally obtained.

As described above, when the physical quantity (the nucleus stopping power or diffusion coefficient in the above case) related to material properties in silicon of the impurity is calculated once by any method, a three-dimensional concentration distribution of the impurity in silicon can be obtained by a simulation from the parameters in the fabricating process.

(2) Secondary Ion Mass Spectroscopy (SIMS)

In the case of actually recognizing a distribution of impurity concentration in a semiconductor substrate, secondary ion mass spectroscopy (SIMS) is used. In the SIMS, the surface of the semiconductor substrate is irradiated with primary ions of Ar⁺ or the like at an energy of 100 eV to 30 keV, and charge particles (secondary ions) out of particles emitted from the surface of the silicon substrate by a sputtering phenomenon are analyzed by mass spectroscopy, thereby identifying the kind and quantity of an element. By scanning the surface with a primary ion beam, a two-dimensional impurity distribution can be obtained.

Atoms exposed at the observed surface are removed by observation and the observation is made while always exposing a new surface, so that information of the impurity concentration in the depth direction can be also obtained.

The resolution in the two-dimensional direction of the SIMS depends on a converging system of the primary ion beam. Although a Ga ion beam which is excellently converged can be converged to a spot having a diameter of about 20 nm, the number of ions sputtered decreases by narrowing the diameter of the primary ion beam, so that the sensitivity deteriorates.

The lower the energy of the primary ion is, the higher the resolution in the depth direction is, and the highest resolution is about 1 nm. It is however difficult to obtain a low-energy ion beam at a sufficient current density, so that the strength of the secondary ion deteriorates.

Since a matrix effect exerts a large influence on sputtering with low energy, it is difficult to perform a quantitative analysis. In a practical application having sufficient detection sensitivity, therefore, the spatial resolution is about hundreds nm. Consequently, an apparatus used for the application may be called an IMA (Ion Microprobe Analyzer). There is also an apparatus in which an electron microscope is assembled to improve accuracy of position information.

(3) Electron Microscope

Electron microscopes are roughly divided into two types, a scanning type and a transmission type.

A scanning electron microscope (SEM) scans a sample two-dimensionally with an electron beam converged narrowly, captures secondary electrons emitted from the surface of the sample, and re-constructs the shape of the sample surface from the intensity distribution of the secondary electrons.

Since the emission of secondary electrons varies according to the surface of a material, the differences in materials appear as a contrast in an image. The resolution of an image is as high as a few nm, and the focal depth is deep, so that it is advantageous to evaluate the shape of a rough sample.

A transmission electron microscopy (TEM) irradiates a sample of a thin film (having a thickness of a few nm to tens nm) with a high-speed electron beam, captures the electron beam passed through the sample, and observes an atomic arrangement or a lattice defect of a sample. By using an electron beam having an energy of about 200 keV, resolution of about 0.2 nm is attained.

As application technologies of the electron microscopes, various methods such as a scanning Auger electron microscope, an optical microscope using an X-ray as a source of excitation, an electron probe microanalysis for detecting an X-ray emitted, and a combination of each of the techniques with a magnetic resonance phenomenon are being developed and proposed.

(4) Magnetic Resonance Imaging (MRI)

According to the MRI, the density of atomic nuclei to be observed in a matrix can be observed in a non-destructive manner. By the conventional MRI, the atomic nuclei of hydrogen are objects to be detected and a distribution of water components of an organic sample such as a human body is observed. Since a human body or the like is an object to be detected, an apparatus of MRI is constructed so as to deal with a sample of a certain size.

In the method of obtaining the impurity concentration distribution by a simulation, in reality, the implantation and diffusion phenomenon of the impurity may vary according to the states of the semiconductor substrate of the degree of a crystal defect in a semiconductor substrate, an internal stress, and the like. Consequently, there is a problem such that the impurity concentration distribution obtained by a simulation is not always correct.

According to the method by the SIMS, a sample is destroyed by observation. There is consequently a problem such that a sample cannot be observed in a non-destructive manner.

Further, out of electron microscopes, by the SEM, only the information of the surface can be obtained and there is a problem such that the kind of the element cannot be identified.

Further, the TEM has a problem such that only a sample through which an electron beam can pass can be measured.

The MRI has a low spatial resolution which is at most about 10 μm.

### SUMMARY OF THE INVENTION

The invention has been achieved to solve the problems as described above, and an object of the invention is to provide a magnetic resonance apparatus capable of measuring an impurity concentration distribution in all the area of a sample at high resolution without destroying the sample.

A magnetic resonance apparatus according to an aspect of the invention has: holding means for cooling and holding a sample containing atomic nuclei having a magnetic moment; magnetic field applying means for applying a magnetic field which is inclined so that the magnetic field intensity has a gradient to a reference axis of the sample; driving means for driving the sample to which the magnetic field is applied with respect to the magnetic field; irradiating means for irradiating the sample to which the magnetic field is applied with an electromagnetic wave; and detecting means for detecting an electromagnetic wave emitted from the sample irradiated with the electromagnetic wave.

In the magnetic resonance apparatus constructed as described above, a sample is cooled and held by the holding means. In a state where a magnetic field is applied to the sample, an electromagnetic wave is emitted from the irradiating means, so that the intensity of the electromagnetic wave emitted increases. As a result, sufficient signal intensity for improving the resolution can be obtained, and the resolution of the magnetic resonance apparatus can be improved. The distribution of atomic nuclei in the sample can be also known without destroying the sample. Further, the driving means can move the sample with respect to the magnetic field, so that the inclined magnetic field is applied to the entire sample. Thus, the distribution of atomic nuclei of not only the surface but also the inside of the sample can be known.

Preferably, the magnetic field applying means Zeeman-splits the atomic nuclei by applying the magnetic field to the sample.

Preferably, the irradiating means and the detecting means include common antenna devices. In this case, the antenna devices can function as both irradiating means and detecting means, so that the number of components can be reduced.

Preferably, the irradiating means includes a maser. In this case, since the maser has generally a narrow bandwidth and generates a high output, the resolution can be improved by using the maser.

Preferably, the magnetic resonance apparatus further includes control means for controlling an operation of the driving means.

Preferably, the driving means can move the sample along three axes which are linearly independent of each other. In this case, the driving means can move the sample along the three axes which are linearly independent of each other, so that the distribution of impurity concentration in the sample on the three axes which are linearly independent of each other can be known. As a result, the three-dimensional impurity concentration distribution in the sample can be known.

Preferably, the magnetic resonance apparatus further includes a diamagnetic member provided near the magnetic field applying means so as to increase the magnetic field intensity near the sample. In this case, since the diamagnetic member increases the magnetic field intensity near the sample, the resolution can be further improved.

Preferably, the sample is an impurity-doped semiconductor, and the magnetic resonance apparatus measures the concentration of an impurity in the semiconductor in accordance with the electromagnetic wave detected by the detecting means.

A magnetic resonance apparatus according to another aspect of the invention has: holding means for cooling and holding a sample containing atomic nuclei having a magnetic moment; magnetic field applying means for sweeping and applying a magnetic field which is inclined so that the magnetic field intensity has a gradient to a reference axis of the sample; irradiating means for irradiating the sample to which the magnetic field is applied with an electromagnetic wave; and detecting means for detecting the electromagnetic wave emitted from the sample irradiated with the electromagnetic wave.

In the magnetic resonance apparatus constructed as described above, a sample is cooled and held by the holding means. In a state where a magnetic field is applied to the sample, an electromagnetic wave is emitted from the irradiating means, so that the intensity of the electromagnetic wave emitted increases. As a result, sufficient signal intensity for improving the resolution can be obtained, and the resolution of the magnetic resonance apparatus can be improved. The distribution of atomic nuclei in the sample can be also known without destroying the sample. Further, since the gradient magnetic field is swept and applied, the gradient magnetic field is applied to the entire sample. Thus, the distribution of atomic nuclei of not only the surface but also the inside of the sample can be known.

Preferably, the magnetic field applying means Zeeman-splits the atomic nuclei by applying the magnetic field to the sample.

Preferably, the irradiating means and the detecting means include common antenna devices. In this case, the antenna devices function as both the irradiating means and the detecting means, so that the number of components can be reduced.

Preferably, the irradiating means includes a maser. In this case, since the maser has generally a narrow bandwidth and generates a high output, the resolution can be improved by using the maser.

Preferably, the magnetic resonance apparatus further includes control means for controlling the intensity of the magnetic field applied to the sample by the magnetic field applying means.

Preferably, the magnetic field applying means includes a pair of first coils provided along a first axis, a pair of second coils provided along a second axis linearly independent of the first axis, and a pair of third coils provided along a third axis linearly independent of the first and second axes. In this case, the driving means can sweep and apply the magnetic field along the three axes which are linearly independent of each other, so that the impurity concentration distribution in the sample on the three axes which are linearly independent of each other can be known. As a result, the three-dimensional impurity concentration distribution in the sample can be known.

Preferably, the magnetic resonance apparatus further has a diamagnetic member provided near the magnetic field applying means so as to increase the magnetic field intensity near the sample. In this case, the diamagnetic member increases the magnetic field intensity near the sample, so that the resolution can be further improved.

Preferably, the sample is an impurity-doped semiconductor, and the magnetic resonance apparatus measures the concentration of an impurity in the semiconductor in accordance with the electromagnetic wave detected by the detecting means.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of a magnetic resonance apparatus according to a first embodiment of the invention;

FIG. 2A is a cross section of the magnetic resonance apparatus, FIG. 2B is a perspective view of coils and antennas, and FIG. 2C is a plan view of the coil;

FIG. 3 is a schematic diagram showing Zeeman splitting;

FIG. 4 is a diagram for explaining the principle of MRI;

FIG. 5 is a perspective view showing the relations between a sample and X, Y, and Z axes;

FIG. 6 is a schematic view showing the relations between a sample and the X and Z axes;

FIGS. 7 to 9 are diagrams for explaining the intensity of a magnetic field applied to a sample in a first process;

FIGS. 10 to 12 are diagrams for explaining the intensity of a magnetic field applied to a sample in a second process;

FIG. 13 is a diagram showing a sample of which position is changed by a driving mechanism;

FIGS. 14 to 16 are diagrams for explaining the intensity of a magnetic field applied to a sample in a third process;

FIGS. 17 to 19 are diagrams for explaining the intensity of a magnetic field applied to a sample in a fourth process;

FIG. 20 is a diagram showing a sample of which position is changed by the driving mechanism;

FIGS. 21 to 23 are diagrams for explaining the intensity of a magnetic field applied to a sample in a fifth process;

FIGS. 24 to 26 are diagrams for explaining the intensity of a magnetic field applied to a sample in a sixth process;

FIG. 27 is a block diagram of a magnetic resonance apparatus according to a second embodiment of the invention;

FIG. 28 is a perspective view of coils shown in FIG. 27;

FIGS. 29 to 31 are diagrams for explaining the intensity of the magnetic field applied to the sample in the first process;

FIGS. 32 to 34 are diagrams for explaining the intensity of the magnetic field applied to the sample in the second process;

FIG. 35 is a block diagram of a magnetic resonance apparatus according to a third embodiment of the invention;

FIG. 36 is a cross section of a magnetic resonance apparatus according to a fourth embodiment of the invention; and

FIG. 37 is a block diagram of a magnetic resonance apparatus according to a fifth embodiment of the invention.

### DESCRIPTION OF THE PREFERRED EMBODIMENTS

Embodiments of the invention will now be described hereinbelow with reference to the drawings.

### First Embodiment

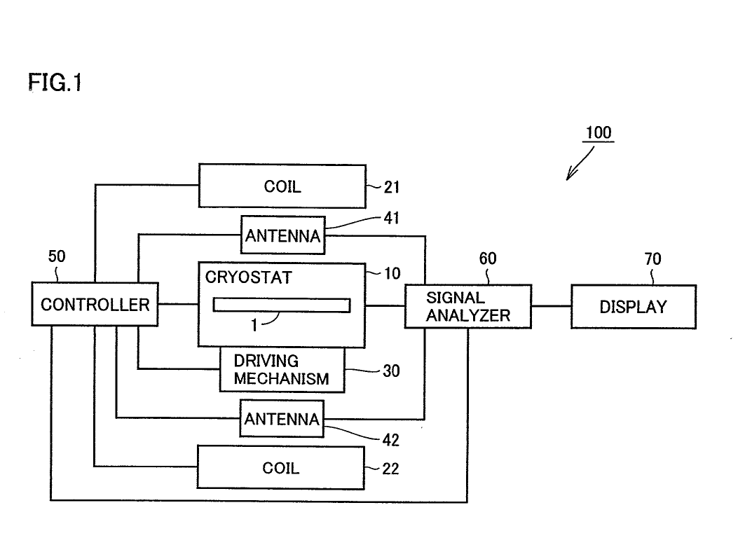

Referring to FIG. 1, a magnetic resonance apparatus 100 according to a first embodiment of the invention has: a cryostat 10 as holding means for cooling and holding a sample 1 including an atomic nucleus having a magnetic moment; coils 21 and 22 as magnetic field applying means for applying an inclined magnetic field to sample 1 so that the intensity of the magnetic field has a gradient to the reference axis of sample 1; a driving mechanism 30 as driving means for moving sample 1 to which the magnetic field is applied with respect to the magnetic field; antennas 41 and 42 as irradiating means for irradiating sample 1 to which the magnetic field is applied with an electromagnetic wave; and antennas 41 and 42 as detecting means for detecting an electromagnetic wave emitted from sample 1 irradiated with the electromagnetic wave.

Coils 21 and 22 Zeeman-splits the atomic nucleus by applying the magnetic field to sample 1. The irradiating means and the detecting means include common antennas 41 and 42. Magnetic resonance apparatus 100 further includes a controller 50 as control means for controlling the operation of driving mechanism 30.

Driving mechanism 30 can move sample 1 along three axes linearly independent of each other. Sample 1 is an impurity-doped semiconductor, and magnetic resonance apparatus 100 measures the impurity concentration in the semiconductor in accordance with the electromagnetic wave detected by antennas 41 and 42 as detecting means.

Cryostat 10 is positioned in the center of the apparatus. Cryostat 10 is fixedly placed on driving mechanism 30. Driving mechanism 30 can move cryostat 10 and sample 1 held by cryostat 10 three-dimensionally.

A pair of antennas 41 and 42 are provided so as to sandwich cryostat 10. Antennas 41 and 42 are provided so as to face each other, irradiate sample 1 with an electromagnetic wave, and detect the electromagnetic wave emitted from sample 1. As each of antennas 41 and 42, a loop antenna is used.

On both sides of antennas 41 and 42, a pair of coils 21 and 22 are provided. By passing a predetermined current into coils 21 and 22, a magnetic field is generated. Coils 21 and 22 apply the magnetic field to sample 1.

Controller 50 is connected to cryostat 10, coils 21 and 22, driving mechanism 30, and antennas 41 and 42 and sends signals to those elements. A signal analyzer 60 is connected to cryostat 10, driving mechanism 30, and antennas 41 and 42. Signal analyzer 60 and controller 50 are connected to each other.

Signal analyzer 60 is connected to a display 70. Signals collected by signal analyzer 60 are processed in signal analyzer 60, and displayed as an image on display 70.

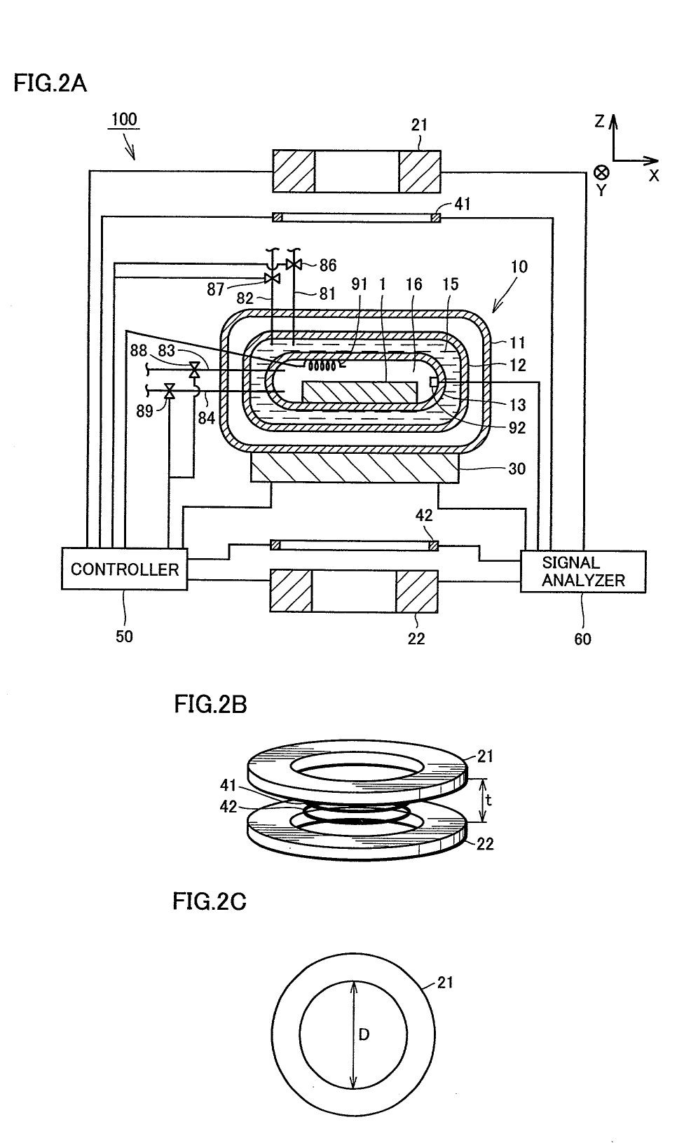

FIG. 2A is a cross section of a magnetic resonance apparatus, FIG. 2B is a perspective view of coils and antennas, and FIG. 2C is a plan view of the coil. Referring to FIGS. 2A to 2C, the structure of magnetic resonance apparatus 100 according to the invention will be described in detail.

(1) Coils 21 and 22

A magnet by which the strongest magnetic field can be obtained at present is an air-cored superconducting magnet. Coils 21 and 22 construct an electromagnet. In proportional to the number of turns of each of coils 21 and 22 and the current passed to coils 21 and 22, the stronger magnetic force can be generated.

As a wire material of coils 21 and 22 made of a superconductor, Nb₃Sn can be used. By passing a current of about 250A to coils 21 and 22, a magnetic field having the intensity of about 20T can be realized. In order to obtain a stronger magnetic field, an oxide superconductor can be used as the material of coils 21 and 22. Coils 21 and 22 are put in a thermal insulation vessel filled with liquid helium. To suppress evaporation of the liquid helium, the vessel is further put in a thermal insulation vessel filled with liquid nitrogen.

In the case of a general MRI apparatus, the region of a sample to be observed is large, and an uniform magnetic field has to be applied to the whole region. Consequently, the main magnet usually has to have a diameter of 10 cm or larger. In addition, an electromagnet called “shim” for adjusting the uniformity is also provided. In the invention, however, the region to which an ultra high magnetic field is applied may be 1 cm² or smaller, the shim is not needed.

It is desirable to reduce the diameter D of each of coils 21 and 22 (refer to FIG. 2C) and the interval (t) (refer to FIG. 2B) between coils 21 and 22 in order to increase the magnetic flux density in the region of the sample 1. When the object to be observed has high spatial density like a hydrogen atomic nucleus contained in a photoresist applied on sample 1 which is a silicon substrate, a coil having a diameter of about 30 cm may be used. In the case of observing a small amount of atomic nuclei of arsenic or the like implanted in the silicon substrate, it is advantageous to use a coil having the diameter D of 1 cm or less as shown in FIG. 2C.

The intensity of the magnetic field becomes weaker with distance from coils 21 and 22 for the reason that lines of magnetic force expand in space and the density of the lines decreases. It is therefore preferable that the distance between sample 1 and coils 21 and 22 is shorter. In order to avoid attenuation of the magnetic field, it is advantageous that two magnetic poles (coils) of different polarities are disposed so as to sandwich a region for holding sample 1 and the interval between the magnetic poles is narrowed as much as possible. In the case of using the silicon substrate as sample 1, its thickness is 10 mm or less, and the silicon substrate is preferably has a large size so that a structure of a certain size can be mounted for controlling the temperature of sample 1 or the like. It is preferable that the interval t between coils 21 and 22 is 10 cm or less, and the distance between sample 1 and each of the coils 21 and 22 is 5 cm or less.

The electromagnet for applying an ultra high magnetic field may perform a pulse operation. In this case, a magnetic field of higher intensity as compared with a continuous operation can be generated.

It is necessary to apply a gradient magnetic field to the sample and scan the magnetic field intensity three-dimensionally. For this purpose, there are two methods; a method of electrically changing the magnetic field intensity by two or more sets of electromagnets (coils), and a method of physically moving the position of the sample while fixing the magnetic field. From a viewpoint of the apparatus configuration, it is preferable to adopt the former method, that is, the method of electrically changing the magnetic field intensity by two or more sets of electromagnets and obtain a spatial distribution of the nuclei to be observed by signal analysis because the apparatus configuration becomes simple. By narrowing the interval of the strong magnetic field areas, a magnetic field gradient of 100 mT/m or more can be realized. Preferably, the area (magnetic pole area) of the face of the coil 21 facing the coil 22 is set to 750 cm² or less.

(2) Holding Means (Cryostat 10)

The lower the temperature of the sample is, the stronger an MRI signal becomes from the principle of the signal. However, a main object to be observed of a conventional MRI apparatus is a hydrogen atomic nucleus contained in water components in a living body, so that the temperature of the sample cannot be set to be very low. In the invention, it is expected that the objects to be observed are phosphorus, arsenic, or the like in the silicon substrate, so that the holding means can be cooled by liquid nitrogen, liquid helium, or the like. Consequently, a structure capable of cooling the holding means by liquid nitrogen, liquid helium, or the like can be used. A thermostat used for such a purpose is usually cryostat 10.

Cryostat 10 has a three-layered structure and is constructed by three walls 11, 12, and 13. The area surrounded by walls 11 and 12 is a thermal insulating layer, an interlayer between walls 12 and 13 is a coolant layer, and an area surrounded by wall 13 is a sample chamber.

Sample 1 is loaded in the sample chamber. The sample chamber is filled with liquid or gaseous helium 16. A heater 91 is provided. Heater 91 may be provided on the outside of the sample chamber. In the sample chamber, a helium introduction pipe 83 and a helium exhaust pipe 84 are provided. Through helium introduction pipe 83, liquid or gaseous helium 16 as a coolant is introduced into the sample chamber. Through helium exhaust pipe 84, helium is exhausted from the sample chamber to the outside.

Helium introduction pipe 83 and helium exhaust pipe 84 are provided with valves 88 and 89, respectively. Valves 88 and 89 are opened/closed by controller 50.

In the sample chamber, a temperature sensor 92 is provided and connected to signal analyzer 60.

Wall 13 constructing the sample chamber is made of, preferably, a material having high thermal conductivity. The material has to have purity to a degree that sample 1 is not contaminated since wall 13 comes into direct contact with the backside of sample 1. When the temperature of sample 1 is increased to be high while a contamination material is adhered, there is the possibility that the contamination substance is diffused in sample 1. In the apparatus, the temperature is kept lower than the normal room temperature.

The space between walls 12 and 13 is filled with liquid nitrogen 15. The sample chamber is filled with helium 16. Liquid nitrogen is introduced via a liquid nitrogen introduction pipe 81 and exhausted via a liquid nitrogen exhaust pipe 82. Liquid nitrogen introduction pipe 81 and liquid nitrogen exhaust pipe 82 are provided with valves 86 and 87, respectively. The valves 86 and 87 are connected to controller 50. The space between walls 11 and 12 is under vacuum.

Since the temperature in the cryostat 10 becomes very low, if there is moisture or oxygen in the cryostat 10, it is frozen or liquefied. It is therefore preferable to provide an exhaust pump to preliminarily eliminate the molecules. When the gas in the sample chamber is replaced with helium, stability is obtained and measurement can be performed easily. In the case of cooling sample 1 to the temperature of the liquid helium, the liquid helium can be poured via helium introduction pipe 83 into the sample chamber. Preferably, sample 1 is set to the temperature 100K or lower. The X and Z axes of the face of sample 1 are parallel to the drawing sheet and the Y axis is perpendicular to the drawing sheet.

(3) Irradiating Means and Detecting Means (Antennas 41 and 42)

Usually, a nuclear magnetic resonance phenomenon is excited in MRI by a radio wave as the electromagnetic wave emitted from loop antennas 41 and 42. The antennas 41 and 42 also serve as detecting means for receiving resonance signals. The spatial resolution of the MRI is inversely proportional to the frequency width of the radio wave. The narrower the frequency distribution is, the higher the resolution is. There is a maser as means for obtaining an electromagnetic wave having a narrow frequency width. Since the maser generates an electromagnetic wave having, as a principle, a single frequency and high energy density, which can be easily subjected to pulse operation, the maser is advantageous as an exciting source of MRI.

A signal analyzer 60 similar to that in the conventional another MRI apparatus can be used. Methods of measuring an MRI signal include a saturation recovering method, an inversion recovering method, and the like. In the invention, those methods can be similarly used.

In MRI of which object to be observed is a living body, since the object cannot be fixed, measurement of long observation time cannot be performed. In the case where a not-living body is measured, by adding up results of repetitive measurement, the SIN ratio of the signal can be improved.

By the improvements as described above, much higher sensitivity as compared with a conventional MRI apparatus is obtained. In the case where 10¹⁶ atoms of phosphorus, boron, or the like per 1 cm³ are distributed in a matrix of silicon, a three-dimensional distribution can be observed at a spatial resolution of about 0.1 μm.

(4) Driving Mechanism

Driving mechanism 30 supports cryostat 10 and can move cryostat 10 in linearly-independent three directions. Consequently, the distribution of the impurity concentration in sample 1 can be three-dimensionally measured.

The principle of the MRI will now be described. An atomic nucleus having a spin quantum number I and a magnetic moment μ mutually acts with a magnetic field B, and the degenerated energy level is split to 2I+1. This is called Zeeman splitting. In the case of a hydrogen atomic nucleus (having the number of proton of 1) as a representative object to be observed, the spin quantum number I is 1/2+EE. In the magnetic field, the energy level is split into two energy levels.

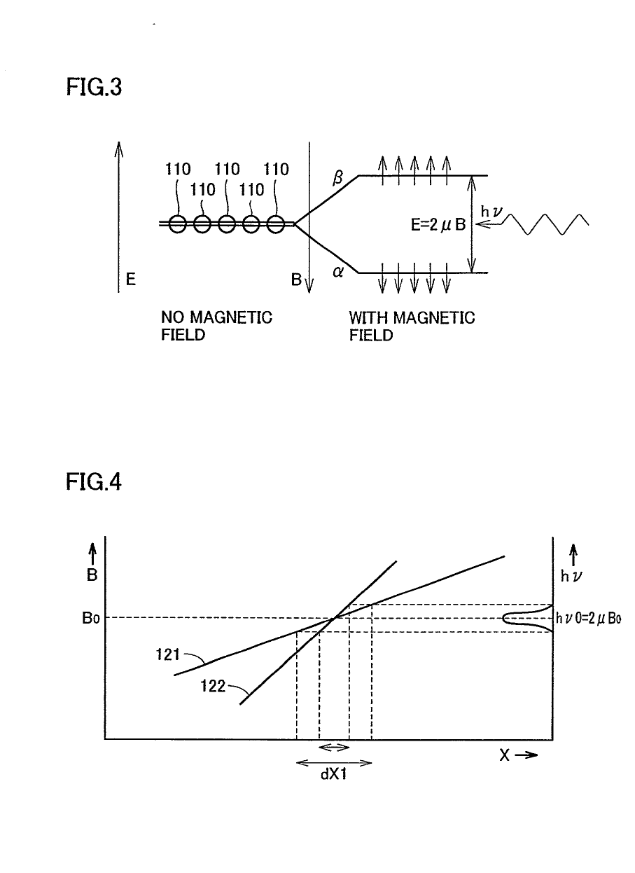

Referring to FIG. 3, in a state where there is no magnetic field, hydrogen atomic nuclei 110 have a single energy level. In contrast, in a state where there is a magnetic field, hydrogen atomic nuclei 110 are split into two energy levels. The level on a low energy side with the same orientation of a nuclear spin as that of the magnetic field B is set as α, and the level on a high energy side with the opposite orientation is set as β. The ratio between the number Nα of α spins and the number Nβ of β spins is expressed as Nβ/Nα=exp(−E/kT) in accordance with the Boltzmann's distribution rule, where k denotes a Boltzmann's constant, T indicates an absolute temperature, and E expresses energy shown by 2 μB.

When Zeeman-split atomic nucleus is irradiated with an electromagnetic wave having a frequency v and the energy hv is equal to E, a resonance phenomenon takes place. h denotes a Planck's constant. By the resonance phenomenon, the electromagnetic wave is emitted as a nuclear magnetic resonance (NMR) signal. The intensity of the NMR signal is proportional to the number of excitable atomic nuclei (Nα−Nβ)/2. The expression can be modified as follows.

Nα−Nβ=Nα(1−Nβ/Nα)

=Nα(1−exp(E/kT))

=Nα(1−exp(−2 μB/kT))

From the equation, it is understood that the higher the magnetic field intensity is and the lower the temperature is, a signal of a stronger intensity can be obtained.

Nα−Nβ of the protons (hydrogen atomic nuclei) will be estimated. When flux density B is 2.35T (corresponding to 100 MHz) and T=300K, Nα−Nβ=0.00001. When there are 100,000 β spins, α spins of 100,000+1 exist. Similarly, when B=23.5T (corresponding to 1 GHz) and T=300K, Nα−Nβ=0.00016. When B=2.35T (corresponding to 100 MHz) and T=4.2K, Nα−Nβ=0.00114. It is understood that in the above range of the magnetic field intensities and temperatures, the number of excitable atomic nuclei, that is, the signal intensity is almost proportional to the magnetic field intensity and inverse proportional to the absolute temperature.

Even if a number of excitable atomic nuclei exist, if they are not actually excited, no signal is obtained. In order to have a signal of a high S/N ratio, therefore, an electromagnetic wave of sufficient intensity has to be emitted.

To obtain the NMR signal by the method as described above, the intensity of the magnetic field to be applied and the frequency of the electromagnetic wave are set so that the resonance condition is satisfied only in a very small space. By three-dimensionally sweeping the very small space, a three-dimensional image of the signal intensity can be obtained. This is the principle of the MRI.

Usually, in the MRI, by applying a gradient magnetic field to a sample and emitting an electromagnetic wave of a narrow band frequency, the resonance condition is satisfied only in a plane-shaped area. By analyzing signals obtained by sweeping the plane area in the vertical and horizontal directions with respect to the sample by a computer, a three-dimensional image is reconstructed.

Referring to FIG. 4, for example, it is now assumed that the intensity of the magnetic field having a gradient (a) in the X axis direction is expressed by a straight line 121 and a resonance condition hν₀=2 μB₀ is satisfied at a position of a magnetic field intensity B₀ in the magnetic field. The atomic nuclei contributed to emission of the NMR signal are distributed in a plane perpendicular to the X axis. When the incident electromagnetic wave does not have a single frequency but a slightly varying frequency and the width of the frequency (upper limit value−lower limit value) is dν, a width dX₁ of the position satisfying the resonance condition is expressed by the following equation.

dX₁=h·dν/2aμ

The narrower the width dv of the frequency is, the thinner the distribution of the atomic nuclei contributed to the NMR signal becomes, and the spatial resolution becomes higher. As shown by a straight line 122, the sharper the gradient of the magnetic field becomes, the thinner the distribution of the atomic nuclei contributed to the NMR signal becomes, and the spatial resolution becomes higher.

In order to improve the spatial resolution of the MRI, therefore, there are the following methods.

(1) To make the gradient of the magnetic field applied to a sample steeper.

(2) To narrow the frequency width of an electromagnetic wave to be emitted.

As described above, by improving the spatial resolution of the MRI, the number of atomic nuclei existing in the space where the resonance condition is satisfied is decreased. It causes reduction in intensity of the NMR signal. In order to realize the MRI apparatus having high resolution, therefore, sufficient signal intensity has to be assured. For this purpose, there are the following methods.

(1) To increase the magnetic field intensity. Concretely, a current passed to the coils constructing the electromagnet is increased, the distance between magnetic poles is shortened, the sample is positioned closer to the magnetic poles, and the like.

(2) To set the temperature of the sample to be low. Concretely, the sample chamber is covered with a thermal insulating material and the inside is cooled by liquid nitrogen or liquid helium.

(3) To increase the strength of an electromagnetic wave to be emitted. Concretely, a maser is used as an electromagnetic wave source. The maser oscillates at a single wavelength, so that it also produces an effect of a narrow frequency band and an improved spatial resolution.

A method of measuring a three-dimensional impurity distribution will now be described.

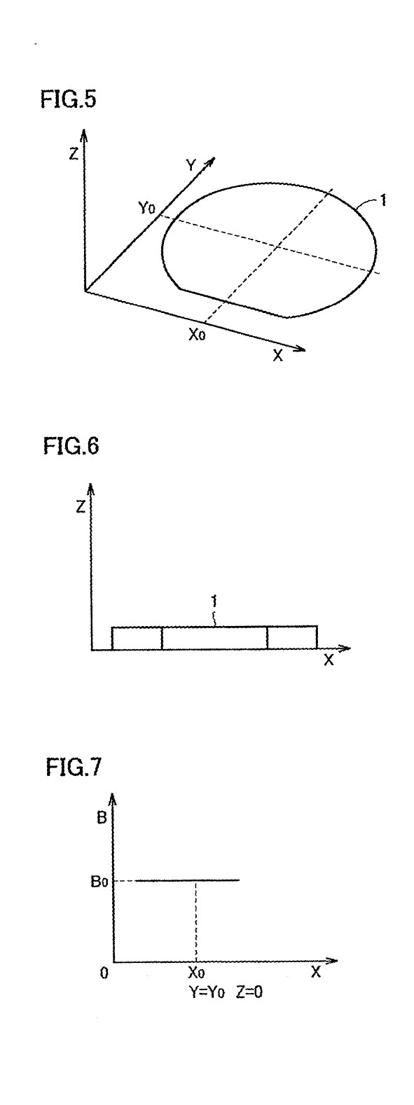

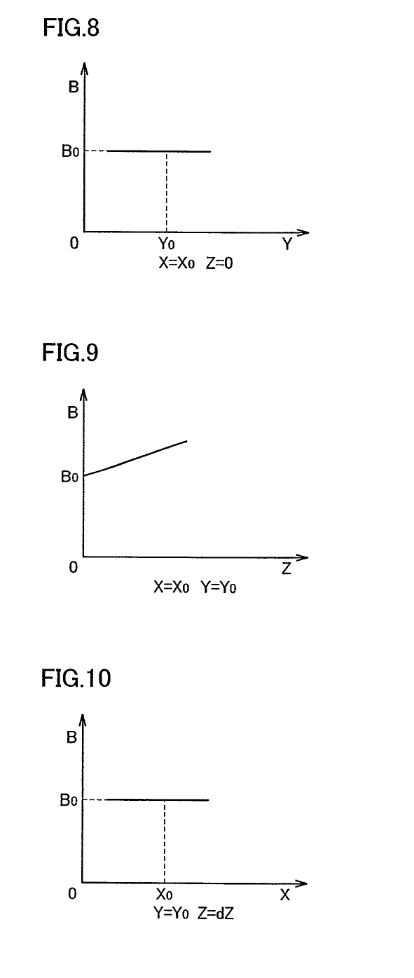

Referring to FIGS. 5 to 9, in a first process, the magnetic field intensity in the plane of Z=0 becomes B₀, and a gradient magnetic field is applied to a sample so as to satisfy the resonance condition. The magnetic field is inclined to the Z axis as a reference axis. On the plane expressed by Z=0, the resonance condition is satisfied. When the electromagnetic wave is emitted from antennas 41 and 42 in such a state, resonance occurs on the plane of Z=0, and antennas 41 and 42 receive NMR signals. The signal intensity added up on the plane of Z=0 can be consequently calculated.

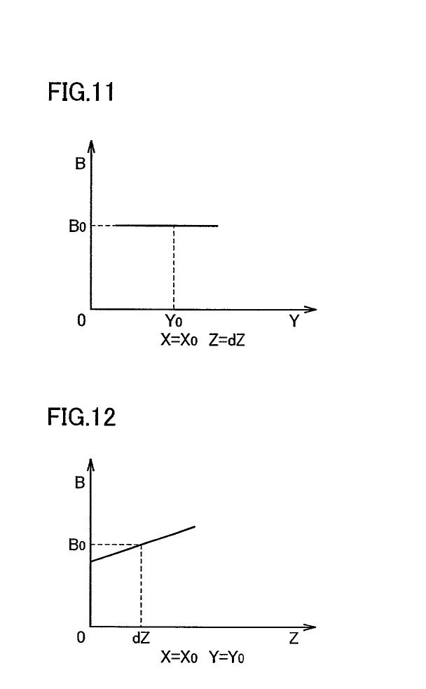

Referring to FIGS. 10 to 12, in a second process, driving mechanism 30 slightly moves cryostat 10 and sample 1 from the state shown in FIG. 2 toward the Z axis direction so that the resonance condition is satisfied on the plane of Z=dZ. By the operation, the resonance condition is satisfied on the plane of Z=dZ. Consequently, resonance signals are obtained and the signal intensity added up on the plane of Z=dZ is measured by antennas 41 and 42.

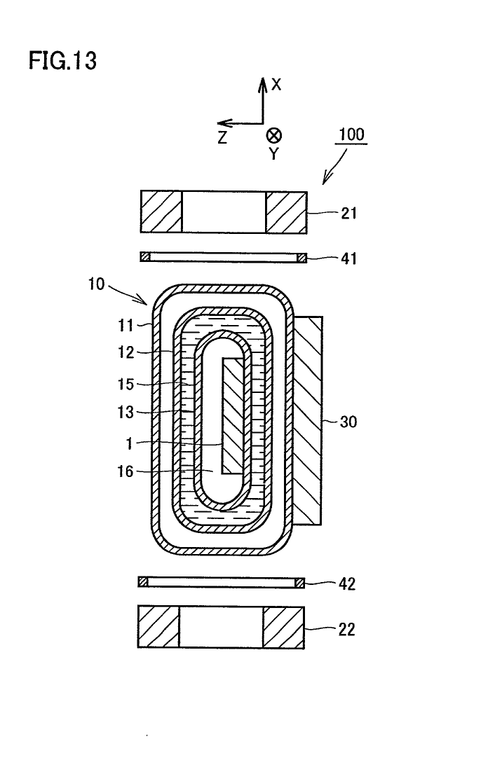

In FIG. 13, attached devices such as controller 50, signal analyzer 60, and display are not shown. Referring to FIG. 13, driving mechanism 30 moves sample 1. By the movement, the X and Z axes in the plane of sample 1 become parallel to the drawing sheet, and the Y axis becomes perpendicular to the drawing sheet. The X axis extends in the direction from the coil 22 toward the coil 21.

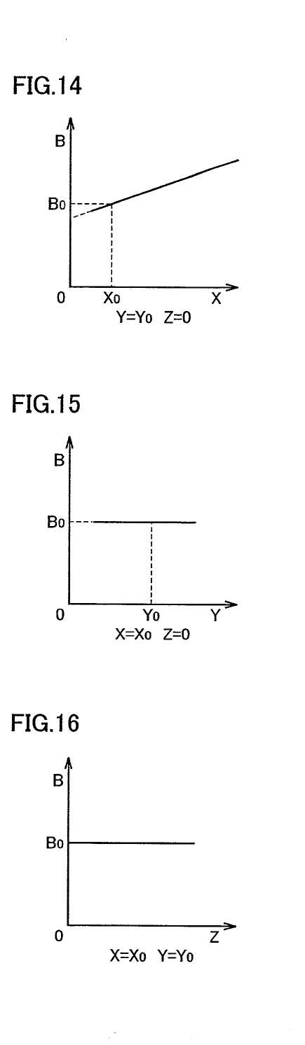

Referring to FIGS. 14 to 16, in the third process, the intensity of the magnetic field becomes B₀ in the plane of X=X₀, the gradient magnetic field is applied to sample 1 so as to satisfy the resonance condition. The magnetic field is inclined to the X axis as a reference axis. The resonance condition is satisfied on the plane expressed by X=X₀. When the electromagnetic wave is emitted from antennas 41 and 42 in such a state, resonance takes place on the plane of X=X₀, and antennas 41 and 42 receive the NMR signals. Consequently, signal intensity added up on the plane of X=X₀ can be obtained.

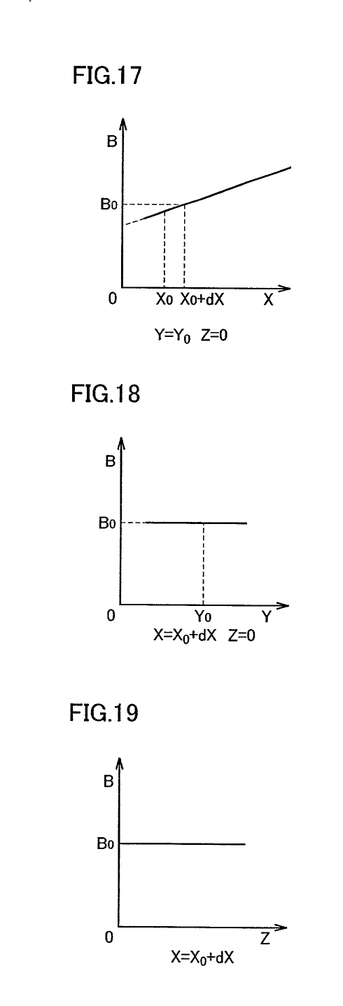

Referring to FIGS. 17 to 19, in a fourth process, driving mechanism 30 slightly moves cryostat 10 and sample 1 in the state shown in FIG. 13 toward the X axis direction so that the resonance condition is satisfied on the plane of X=X₀+dX. By the operation, the resonance condition on the plane of X=X₀+dX is satisfied. The NMR signal is obtained and signal intensity added up on the plane of X=X₀+dX is measured by antennas 41 and 42.

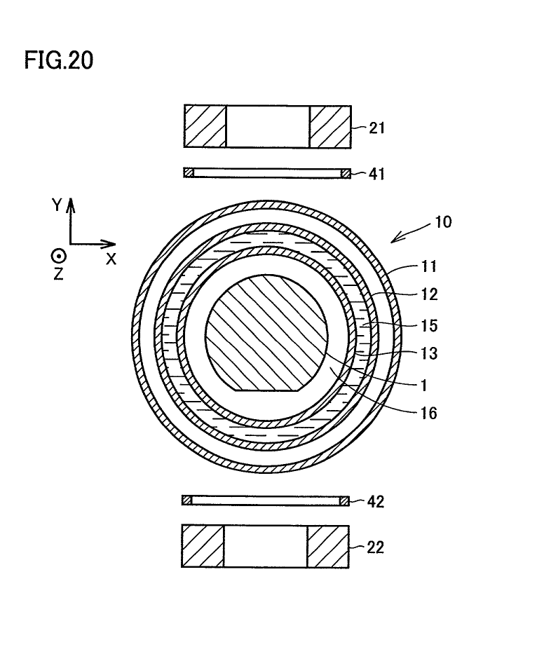

In FIG. 20, attached devices such as controller 50, signal analyzer 60, and display are not shown. Referring to FIG. 20, driving mechanism 30 moves sample 1. By the movement, the X and Y axes in the plane of sample 1 become parallel to the drawing sheet, and the Z axis becomes perpendicular to the drawing sheet. The Y axis extends in the direction from coil 22 toward coil 21.

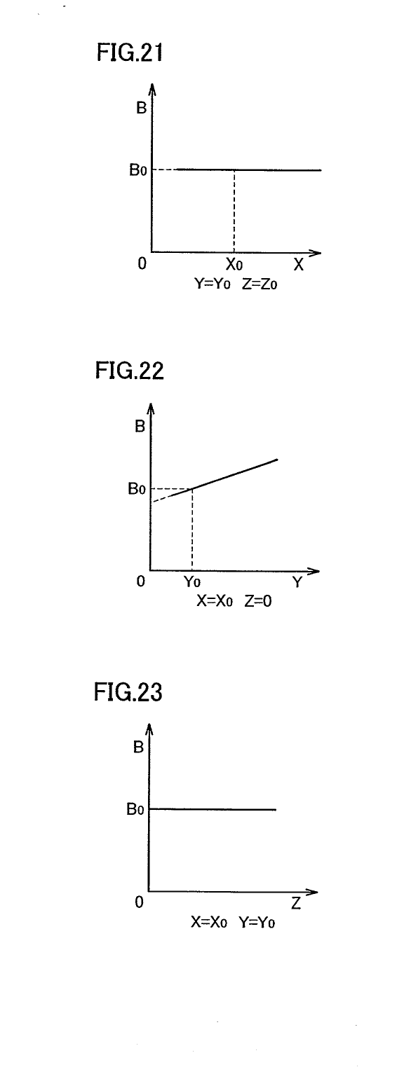

Referring to FIGS. 21 to 23, in a fifth process, the intensity of the magnetic field becomes B₀ in the plane of Y=Y₀, and the gradient magnetic field is applied to sample 1 so as to satisfy the resonance condition. The magnetic field is inclined to the Y axis as a reference axis. The resonance condition is satisfied on the plane expressed by Y=Y₀. When the electromagnetic wave is emitted from antennas 41 and 42 in such a state, resonance occurs on the plane of Y=Y₀, and antennas 41 and 42 receive the NMR signals. Consequently, signal intensity added up on the plane of Y=Y₀ can be obtained.

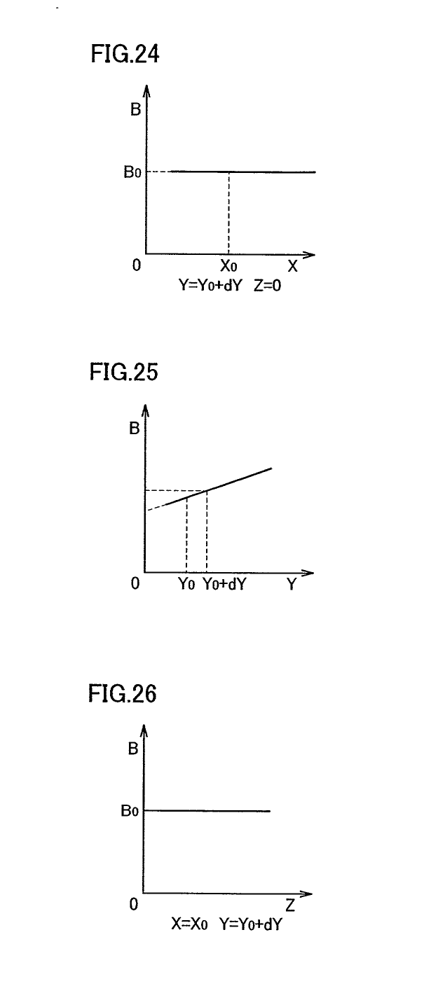

Referring to FIGS. 24 to 26, in a sixth process, driving mechanism 30 slightly moves cryostat 10 and sample 1 in the state shown in FIG. 20 toward the Y axis direction so that the resonance condition is satisfied on the plane of Y=Y₀+dY. By the operation, the resonance condition on the plane of Y=Y₀+dY is satisfied. The NMR signal is obtained and signal intensity added up on the plane of Y=Y₀+dY is measured by antennas 41 and 42.

By moving the sample three-dimensionally in such a manner, the three-dimensional distribution of the impurity in sample 1 can be obtained without destroying sample 1. Further, since sample 1 is cooled, the distribution of the impurity can be obtained with high accuracy.

### Second Embodiment

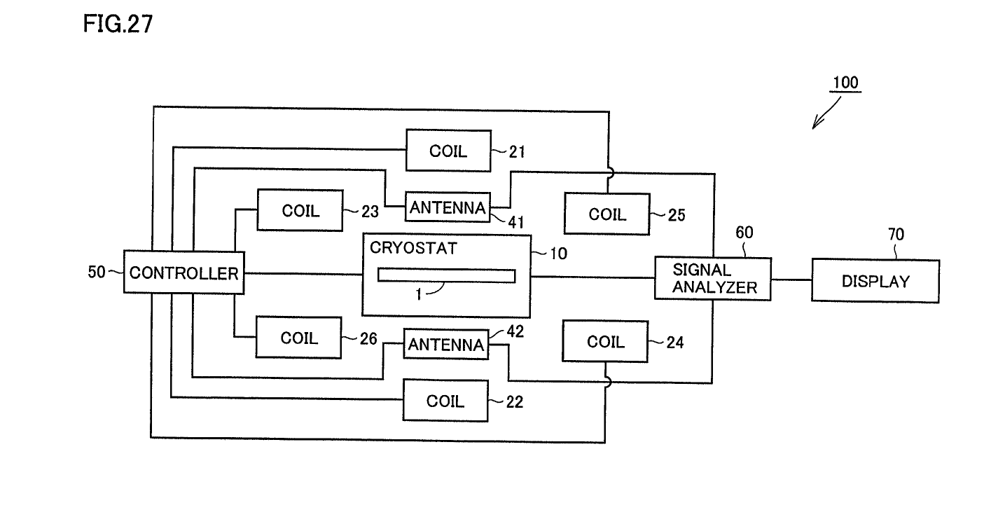

Referring to FIG. 27, a magnetic resonance apparatus 100 according to a second embodiment of the invention has: a cryostat 10 as holding means for cooling and holding sample 1 including an atomic nucleus having a magnetic moment; coils 21, 22, 23, 24, 25, and 26 as magnetic field applying means for sweeping a magnetic field inclined so that the intensity of the magnetic field inclines with respect to the reference axis of sample 1 and applying the swept magnetic field to sample 1; antennas 41 and 42 as irradiating means for irradiating sample 1 to which the magnetic field is applied with an electromagnetic wave; and antennas 41 and 42 as detecting means for detecting an electromagnetic wave emitted from sample 1 irradiated with the electromagnetic wave. Coils 21 and 22 as magnetic field applying means Zeeman-splits the atomic nuclei by applying the magnetic field to sample 1. The irradiating means and the detecting means include the common antennas 41 and 42. Magnetic resonance apparatus 100 further includes controller 50 as control means for controlling the intensity of the magnetic field applied by coils 21, 22, 23, 24, 25, and 26 as magnetic field applying means to sample 1. Sample 1 is an impurity-doped semiconductor, and magnetic resonance apparatus 100 measures the impurity concentration in the semiconductor in accordance with the electromagnetic wave detected by antennas 41 and 42.

The intensity of the magnetic field generated by each of coils 21, 22, 23, 24, 25, and 26 can be changed by controller 50. Specifically, controller 50 can change the intensity of the magnetic field generated by each of coils 21 to 26 by adjusting the current passed to each of coils 21 to 26. Consequently, each of coils 21 to 26 can sweep the magnetic field and apply the swept magnetic field to sample 1.

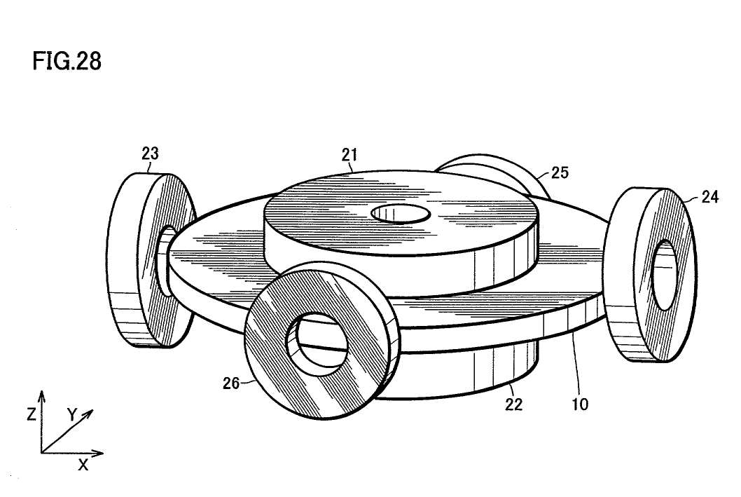

Referring to FIG. 28, coils are provided around cryostat 10. The axis connecting coils 23 and 24 is the X axis, the axis connecting coils 26 and 25 is the Y axis, and the axis connecting coils 21 and 22 is the Z axis. The magnetic field applying means includes coils 23 and 24 as a pair of first coils, coils 25 and 26 as a pair of second coils provided along the Y axis as the second axis linearly independent of the X axis, and coils 21 and 22 as a pair of third coils provided along the Z axis as a third axis linearly independent of the X and Y axes. Although the X, Y, and Z axes are orthogonal to each other in FIG. 28, the three axes do not always have to be orthogonal to each other but may be linearly independent of each other.

The not-shown antennas are provided between cryostat 10 and coils 21 and 22.

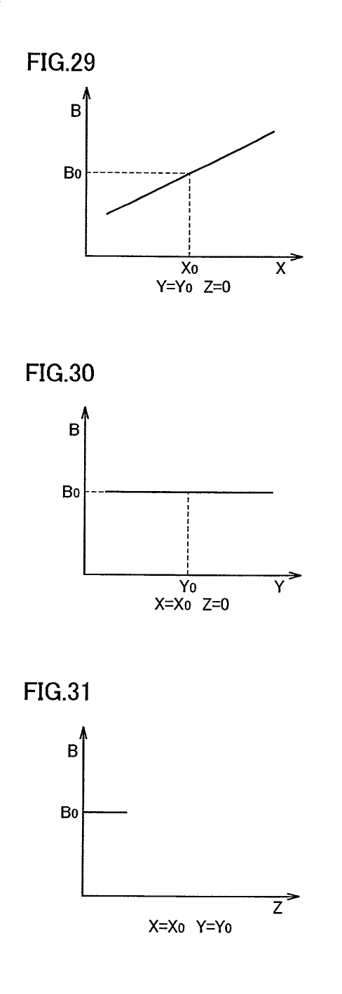

Referring to FIGS. 29 to 31, in the first process, the magnetic field intensity in the plane of X=X₀ becomes B₀, and a gradient magnetic field is applied to the sample so as to satisfy the resonance condition. The magnetic fields as shown in FIGS. 29 to 31 can be realized by passing a current higher than that passed to coil 23 to coil 21, passing the same current to coils 25 and 26, and passing the same current to coils 21 and 22. The magnetic field is inclined to the X axis as a reference axis. On the plane expressed by X=X₀, the resonance condition is satisfied. When the electromagnetic wave is emitted from antennas 41 and 42 in such a state, resonance occurs on the plane of X=X₀, and antennas 41 and 42 receive NMR signals. The signal intensity added up on the plane of X=X₀ can be consequently calculated.

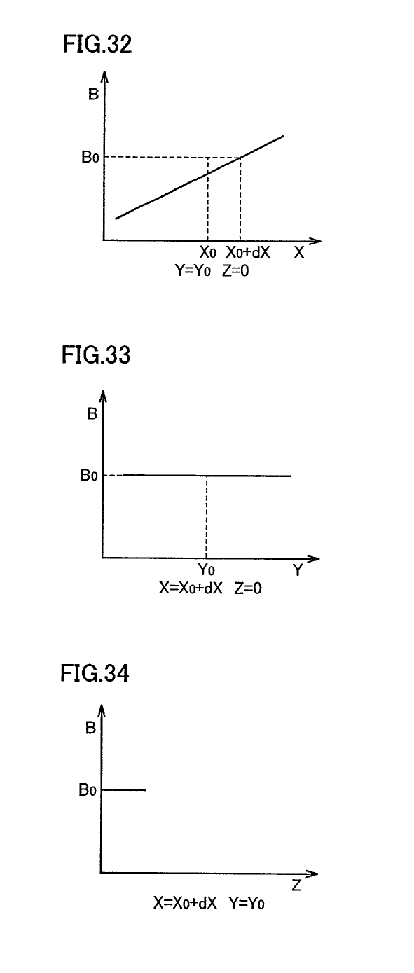

Referring to FIGS. 32 to 34, in the second process, coils 23 and 24 sweep and apply the magnetic field to sample 1 so that the resonance condition is satisfied on the plane of X=X₀+dX. Consequently, resonance signals are obtained and the signal intensity added up on the plane of X=X₀+dX is measured by antennas 41 and 42.

By a similar method, the gradient magnetic field in the Y axis direction and that in the Z axis direction are swept and applied to sample 1. A distribution of the impurity in the plane perpendicular to the Y axis and that in the plane perpendicular to the Z axis can be obtained.

The magnetic resonance apparatus according to the second embodiment of the invention constructed as described above produces effects similar to those in the magnetic resonance apparatus according to the first embodiment.

### Third Embodiment

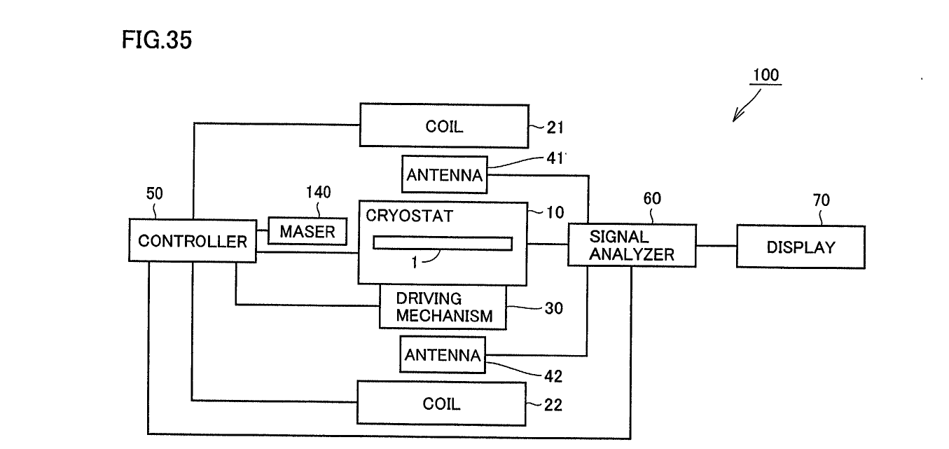

Referring to FIG. 35, a magnetic resonance apparatus 100 according to a third embodiment of the invention is different from magnetic resonance apparatus 100 according to the first embodiment with respect to the point that a maser 140 is used as irradiating means. Maser 140 irradiates sample 1 in cryostat 10 with an electromagnetic wave of a single wavelength. Maser 140 is connected to controller 50. When a predetermined signal is received from controller 50, maser 140 irradiates sample 1 with the electromagnetic wave of the single wavelength.

Magnetic resonance apparatus 100 constructed in such a manner produces effects similar to those of magnetic resonance apparatus 100 according to the first embodiment. Further, since maser 140 irradiates sample 1 with the electromagnetic wave of the single wavelength, an effect of improved resolution of the impurity concentration distribution is produced.

### Fourth Embodiment

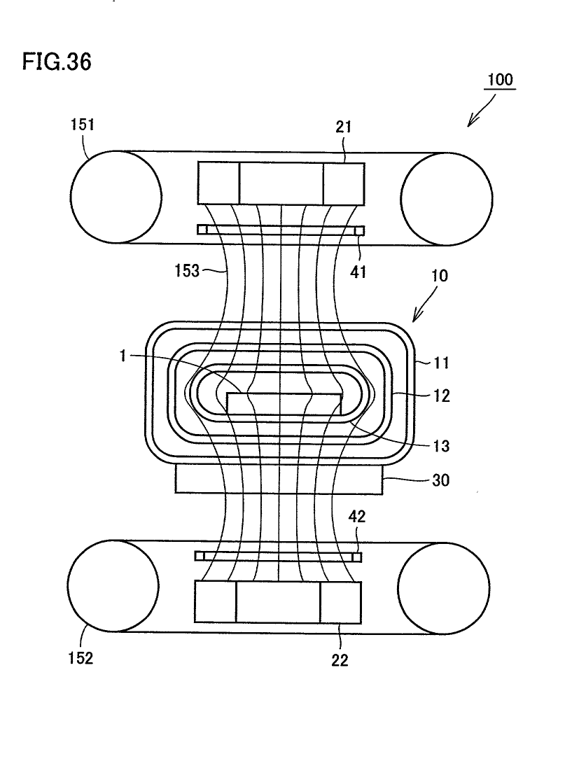

Referring to FIG. 36, a magnetic resonance apparatus 100 according to a fourth embodiment of the invention is different from magnetic resonance apparatus 100 according to the first embodiment with respect to the point that a diamagnetic member (superconductor) 151 is provided near coils 21 and 22 so as to increase the magnetic field intensity near sample 1.

The intensity of the magnetic field applied to sample 1 is expressed by the density of lines of magnetic force passing through sample 1. Consequently, when the lines of magnetic force passing on the outside of sample 1 can be collected to sample 1, the magnetic field intensity increases and the signal intensity can be increased. For this purpose, the fact that the lines of magnetic force cannot pass through a strong diamagnetic material can be used. This is a phenomenon called a Meissner effect, and the phenomenon often occurs in a superconductor. Although the superconductors presently known produce the Meissner effect only at an ultra low temperature, since the sample chamber in the invention has the mechanism for holding an ultra low temperature, the phenomenon can be used. Specifically, the superconductor is disposed around the sample chamber and the ultra low temperature is set, thereby lines of magnetic force which are supposed to pass through the space in which the superconductor is placed can be collected to sample 1. This is realized by using the phenomenon that the magnetic permeability in the diamagnetic material becomes zero. Any substance which is as long as a superconductor can be used. As a substance displaying the Meissner effect at a relatively high temperature, Y—Ba—Ca—O ceramics and bismuth ceramics are known. Obviously, when a substance displaying strong diamagnetism at room temperature is used, it is unnecessary to set an ultra low temperature.

Magnetic resonance apparatus 100 according to the fourth embodiment of the invention also produces effects similar to those of magnetic field resonance apparatus 100 according to the first embodiment. Further, since the lines of magnetic force can be collected to sample 1, the resolution can be further improved.

### Fifth Embodiment

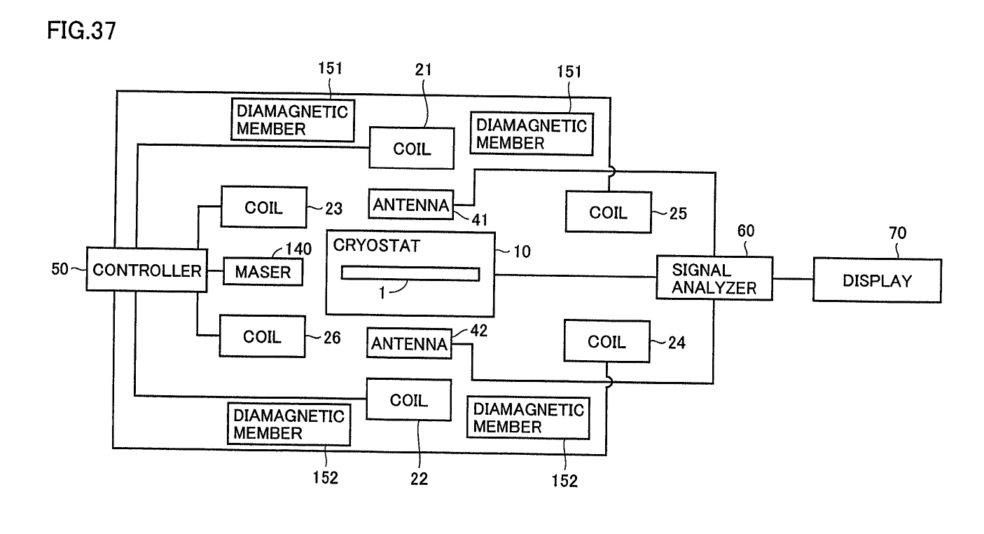

Referring to FIG. 37, a magnetic resonance apparatus 100 according to the fifth embodiment of the invention is different from magnetic resonance apparatus 100 according to the second embodiment with respect to the point that diamagnetic members 151 and 152 are provided near coils 21 and 22 and maser 140 is provided as irradiating means.

Magnetic resonance apparatus 100 according to the fourth embodiment of the invention also produces effects similar to those of magnetic field resonance apparatus 100 according to the fourth embodiment. Further, since maser 140 irradiates the sample 1 with the electromagnetic wave of the single wavelength, an effect such that the resolution of the impurity concentration distribution is further improved is produced.

According to the invention, the distribution of atomic nuclei in a sample can be obtained at high resolution without destroying the sample.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A magnetic resonance apparatus comprising:
holding means for cooling and holding a sample containing atomic nuclei having a magnetic moment;
magnetic field applying means for applying a magnetic field which is inclined so that the magnetic field intensity has a gradient to a reference axis of the sample;
driving means for driving the sample to which the magnetic field is applied with respect to the magnetic field;
irradiating means for irradiating the sample to which the magnetic field is applied with an electromagnetic wave; and
detecting means for detecting an electromagnetic wave emitted from the sample irradiated with the electromagnetic wave.

2. The magnetic resonance apparatus according to claim 1, wherein said magnetic field applying means Zeeman-splits the atomic nuclei by applying the magnetic field to the sample.

3. The magnetic resonance apparatus according to claim 1, wherein said irradiating means and said detecting means include common antenna devices.

4. The magnetic resonance apparatus according to claim 1, wherein said irradiating means includes a maser.

5. The magnetic resonance apparatus according to claim 1, further comprising control means for controlling an operation of said driving means.

6. The magnetic resonance apparatus according to claim 1, wherein said driving means can move the sample along three axes which are linearly independent of each other.

7. The magnetic resonance apparatus according to claim 1, further comprising a diamagnetic member provided near said magnetic field applying means so as to increase the magnetic field intensity near the sample.

8. The magnetic resonance apparatus according to claim 1, wherein said sample is an impurity-doped semiconductor, and said magnetic resonance apparatus measures the concentration of an impurity in said semiconductor in accordance with the electromagnetic wave detected by said detecting means.

9. A magnetic resonance apparatus comprising:
holding means for cooling and holding a sample containing atomic nuclei having a magnetic moment;
magnetic field applying means for sweeping and applying a magnetic field which is inclined so that the magnetic field intensity has a gradient to a reference axis of the sample;
irradiating means for irradiating the sample to which the magnetic field is applied with an electromagnetic wave; and
detecting means for detecting the electromagnetic wave emitted from the sample irradiated with the electromagnetic wave.

10. The magnetic resonance apparatus according to claim 9, wherein said magnetic field applying means Zeeman-splits the atomic nuclei by applying the magnetic field to the sample.

11. The magnetic resonance apparatus according to claim 9, wherein said irradiating means and said detecting means include common antenna devices.

12. The magnetic resonance apparatus according to claim 9, wherein said irradiating means includes a maser.

13. The magnetic resonance apparatus according to claim 9, further comprising control means for controlling the intensity of the magnetic field applied to the sample by said magnetic field applying means.

14. The magnetic resonance apparatus according to claim 9, wherein said magnetic field applying means includes a pair of first coils provided along a first axis, a pair of second coils provided along a second axis linearly independent of said first axis, and a pair of third coils provided along a third axis linearly independent of said first and second axes.

15. The magnetic resonance apparatus according to claim 9, further comprising a diamagnetic member provided near said magnetic field applying means so as to increase the magnetic field intensity near the sample.

16. The magnetic resonance apparatus according to claim 9, wherein said sample is an impurity-doped semiconductor, and said magnetic resonance apparatus measures the concentration of an impurity in said semiconductor in accordance with the electromagnetic wave detected by said detecting means.
